(19) United States
(12) Patent Application Publication
(10) Pub. No.: US 2017/0126903 A1
(43) Pub. Date: May 4, 2017

(54) SYSTEMS AND METHODS FOR MOBILE DEVICE DATA ACCOUNTING

(71) Applicant: TONE MOBILE LLC, New York, NY (US)

(72) Inventors: Blake Cohen, New York, NY (US); Mark Kaplan, New York, NY (US); Andrew Sispoidis, New York, NY (US); Dominic Savatta, New York, NY (US)

(21) Appl. No.: 15/344,253

(22) Filed: Nov. 4, 2016

Related U.S. Application Data
(60) Provisional application No. 62/250,891, filed on Nov. 4, 2015.

(51) Int. Cl. H04M 15/00; H04L 29/08; H04W 4/24; H04W 24/08

(52) U.S. Cl. CPC H04M 15/62; H04W 24/08; H04L 67/22; H04W 4/24; H04M 15/80

(57) ABSTRACT

A method for tracking data transferred to mobile devices. The method includes receiving a first user request for first content data provided by a content provider, and forwarding the user request to a provider server. The method includes receiving the first content data associated with the first user request, and forwarding the first content data associated with the first user request to the first user mobile device. The method includes determining that the first content data is part of a predetermined set of whitelisted content data. The method includes determining a first amount of data transferred to the first user mobile device when the first content data is forwarded to the first user mobile device. The method includes, based on the determination that the first content data is part of the predetermined set of whitelisted content data, logging the first amount of data.

### CROSS-REFERENCE TO RELATED APPLICATIONS

This application claims priority to U.S. Provisional Application No. 62/250,891, filed Nov. 4, 2015, the entirety of which is incorporated herein by reference.

### FIELD OF INVENTION

This disclosure generally relates to mobile services, and more specifically, to accounting for mobile data use with mobile devices through mobile operators.

### BACKGROUND

Currently, mobile subscribers are generally charged data rates by their mobile network operator (MNO) for any data transferred to the subscriber, regardless of whether the subscriber requested the data. For example, a subscriber may be paying data costs for advertisement, data mining activities, “free” mobile applications, or other data transferred to the subscriber involuntarily. Depending on the subscriber's data plan, these involuntarily data transfers may limit the overall data usage of the subscriber who may have a very lean data plan. Moreover, some consumers may not be able to afford mobile data service at all due to the expense of data plans.

As courtesy to its mobile subscribers and to provide more value, an MNO generally provides particular services to subscribers free of charge on their own network. For example, an MNO may allow subscribers to contact the MNO's customer service or to manage the subscriber's online account without affecting the subscriber's mobile data plan, data usage, etc. Typically, each of these courtesy services are accessed via a uniform resource link (URL) and, in turn, the MNO may “whitelist” each URL to denote that a service is gratis. As a result, the MNO may allow subscribers/customers to use any whitelisted URL without affecting the subscriber's mobile data plan, data usage, etc. In other words, the MNO incurs the data costs on behalf of the subscriber as a courtesy.

### BRIEF DESCRIPTIONS OF THE DRAWINGS

FIG. 1 is a high-level block diagram of a computing environment that implements a mobile service system.

FIG. 2 illustrates an example routine or process flow diagram for mobile device data accounting in accordance the system for mobile device data accounting.

FIG. 3 illustrates an embodiment of platform components in accordance the system for mobile device data accounting.

FIG. 4 illustrates an embodiment of an Application Server Architecture in accordance the system for mobile device data accounting.

FIG. 5 illustrates an embodiment of a Data Sponsoring Proxy Architecture in accordance the system for mobile device data accounting.

FIG. 6 illustrates an embodiment of a Mobile Network Operator Integration in accordance with the system for mobile device data accounting.

FIG. 7 illustrates a workflow diagram of an embodiment of a proxy-forwarding operation and data accounting in accordance the system for mobile device data accounting.

The figures depict a preferred embodiment for purposes of illustration only. One skilled in the art may readily recognize from the following discussion that alternative embodiments of the structures and methods illustrated herein may be employed without departing from the principles described herein.

### SUMMARY

In an embodiment, the disclosure describes a computer-implemented method for tracking data transferred to mobile devices. The method comprises receiving, from a first user mobile device via a digital communication network, a first user request for first content data provided by a content provider. The method includes forwarding the user request to a provider server and receiving, from the provider server, the first content data associated with the first user request. The method includes forwarding, via the digital communication network, the first content data associated with the first user request to the first user mobile device. The method includes determining, via the one or more processors, that the first content data is part of a predetermined set of whitelisted content data, and determining a first amount of data transferred to the first user mobile device when the first content data is forwarded to the first user mobile device. The method also includes logging the first amount of data based on the determination that the first content data is part of the predetermined set of whitelisted content data.

### DETAILED DESCRIPTION

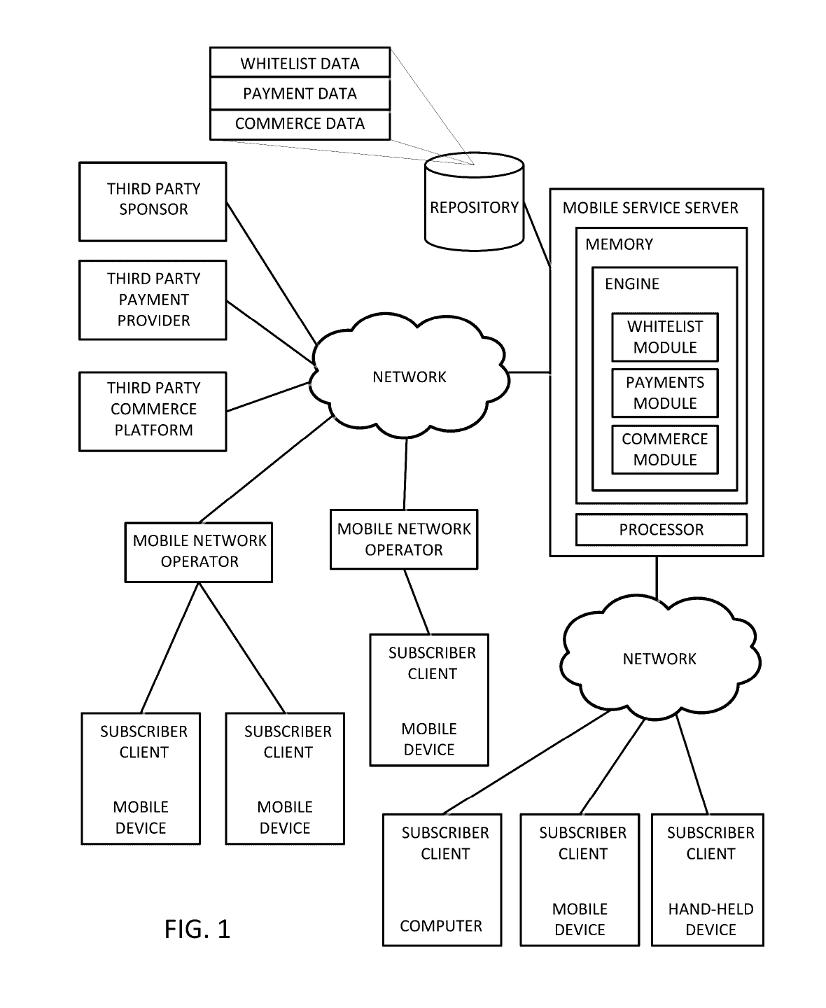

FIG. 1 is a high-level block diagram that illustrates a computing environment for a mobile service system that may be used to allow a mobile subscriber to access mobile data without incurring data costs, or to perform transactions with another subscriber that subscribes to mobile services with a different mobile network operator (MNO). The mobile service server may be, for example, implemented in a computer having a processor, a memory, a computer readable medium or storage unit of any desired type or configuration, and commutatively coupled with a one or more repositories (only one shown in FIG. 1). The memory may store an engine (and an associated whitelist module, payments module, and commerce module) which is configured to communicate with one or more subscriber clients via a network. Each subscriber client includes a processor and a computer readable memory that may execute a browser or anything other application that may request mobile service data from the mobile service server. Any particular subscriber client may be connected to or may be disposed within a user interface device that may be, for example, a hand-held device, such as a smart phone or tablet computer, a mobile device, such as a mobile phone, a wearable mobile device, a computer, such as a laptop or a desktop computer, or any other device that allows a user to interface using the network. Any particular subscriber client may also be connected to or may be disposed within a subscriber client that is only communicatively coupled to a MNO (discussed below). While only three subscriber clients are illustrated in FIG. 1 to simplify and clarify the description, it should be understood that any number of subscriber clients are contemplated and can be in communication with the mobile service server.

The mobile service system also includes one or more mobile network operators that are connected to their own one or more respective subscriber clients through a communication network. The repository, as described above, is connected to or is disposed within the mobile service server and stores content data of any type, including, for example, whitelist data (such as whitelisted URLs, third party sponsors associated with the whitelisted URLs, subscriber usage logs, etc.), payment data (transactional history logs of subscribers' money transfers, types of currency used, etc.), commerce data (historical sales data, products sold, quantities of products sold, billing statements, etc.), and any other type of data that may be used by a mobile subscriber. Generally speaking, the data stored in the repositories may be any data of any type and stored in any organizational manner including structured and unstructured data that may reside in relational and non-relational databases, or any other type of data residing in any other type of storage schema.

As illustrated in FIG. 1, the mobile service server may also be connected to and may communicate with one or more third party sponsors, one or more third party payment providers, and one or more third party commerce platforms through the communication network. Although FIG. 1 only depicts one third party sponsor, one third party payment provider, and one third party commerce platform, any number of third party sponsors, third party payment providers, and third party commerce platforms are contemplated herein. The third party sponsor, which may be stored in a separate dedicated server, for example, may operate to store (or to create, to aggregate, etc.) advertisement data, video, text, image, audio, or any other suitable type of content data intended for a mobile subscriber and may even communicate this content data to the repository depending on different implementations. The content data may be any data generated or stored by a third party sponsor of any type that pertains to, that is associated with, or that is related to content data stored in a third party sponsor database. The third party payment provider, which may also be stored in a separate dedicated server, for example, may operate to store payment data, historical transactions data, authorized user data, authentication data, or any other suitable type of payment data that facilitates in allowing a subscriber to perform financial transactions in any desired currency with another subscriber, financial institution, business, etc. located in the same or a different country than the location or residence of the subscriber. The third party commerce platform, which may also be stored in a separate dedicated server, for example, may operate to store and to provide commerce data that may include product images, product videos, audio recordings of the product, product or service descriptions, product or service prices, product quantities and/or availability, seller/buyer information, product or service reviews, or any other data that may be associated with buying or selling a product or service.

The communication networks may include, but are not limited to, any combination of a LAN, a MAN, a WAN, a mobile, a wired or wireless network, a private network, or a virtual private network. Moreover, while the communication networks are illustrated separately in FIG. 1 to simplify and clarify the description, it is understood that only one network or more than two networks may be used to support communications with respect to the subscriber clients direct coupled to the mobile services server and the subscriber clients coupled to the mobile network operators.

As indicated above, the repository, which may be stored in or may be separate from the mobile service server, may contain any type of data that may facilitate in providing sponsor content to a subscriber or may facilitate the subscriber in conducting a transaction with another party, such as a subscriber associated with a different MNO than the subscriber, a financial institution, or any other second party in a financial transaction. This data may include, but is not limited to, whitelist data, such as a list of URLs (e.g., website link, mobile application, web-based media (images, video, audio, etc.), FTP links, etc.) associated with third party sponsors, such that when a subscriber visits one of the whitelisted URLs (i.e., third party sponsor's URL(s)), the data costs are incurred by the third party and to the subscriber. For example, if a soft drink manufacturer desires to share promotional images, videos, etc. with consumers, the soft drink manufacturer may share one or more selectable (or embedded) URLs with a mobile subscriber via a web browser, mobile app, etc. associated with or embedded in the subscriber client. Continuing this example, if the subscriber selects the provided link or engages with the mobile app, the mobile service server may direct the subscriber to content provided by the soft drink manufacturer and any data transferred to the subscriber will not be charged against the subscriber's account with the MNO. Rather, in this example, the mobile service server may execute a whitelist module stored in the memory of the mobile service server to determine a running account total for the amount of data transferred to all subscribers whom access the sponsor's whitelisted URL and consequently store it as whitelist data in the repository. As described above, the third party sponsor may store the content intended for subscribers on a third party sponsor server and/or repository, and the stored content may include rich media content, such as videos, images, audio, interactive content, etc., file-based content including portable file documents (pdf), word processing documents, image processing documents, compressed files, or any other asset. Any of the content may be may automatically generated or aggregated by an application and stored as application generated data.

The whitelist data can also be accessed by a content editor embedded in the third party sponsor system, can be modified, and can be stored back into one or more of the repositories. Further, a repository does not need to be physically located within mobile service server. For example, the one or more repositories can be stored in external storage attached to the content server, as shown in FIG. 1, or can be stored in a network attached storage. Additionally, there may be multiple mobile service servers that connect to a single repository or a repository may be stored in multiple different or separate physical data storage devices. When executed, the content editor operates to allow a user or a content manager to modify the content data stored in the one or more repositories, for example, to create a content data, to update content data within the one or more repositories or to associate more information, such as a metadata for tracking subscriber usage, views, clicks, etc., with the content data. However, in many cases, content data, including textual content, assets, metadata, application data, etc. may be updated by individuals or particular users associated with the third party sponsor in any desired manner.

As a result of maintaining a running balance for each subscriber accessing the sponsor content associated with a whitelisted URLs, the whitelist module allows subscribers to access and consume content at no cost to the subscriber. Moreover, the whitelist module may track data usage for each sponsor (or for each URL) for each MNO for every subscriber who accessed the sponsor URL(s) and content. The whitelist module may further generate usage reports, billing reports, etc. for a particular sponsor. As an example, a city's department of transportation may wish to incur the costs of their riders whom desire to access a support or customer service website. In another example, a video content stream service may wish to defray some of their customers costs by subsidizing the data costs for those customers whom desire to stream video to their mobile device. On the other hand, the sponsor may desire to directly charge the subscriber for access to the sponsor's web service.

Alternatively, the mobile service server may directly access an MNO's whitelist service to add or update a URL on behalf of a sponsor. In an example, the mobile service server may receive an electronic request to publish a new URL with one or more MNOs from the third party sponsor via the communication network. The mobile service server may execute the whitelist module to transmit to a desired MNO a request to update the whitelist service of the MNO with the new URL received from the third party sponsor. In response, the mobile service server may receive a confirmation from the MNO that the whitelist server of the MNO was properly updated with the new URL. The whitelist module may continue transmitting whitelist URL posting requests to other MNOs that the third party sponsor desires. Additionally, the sponsor may request whether the data usage costs be incurred the sponsor or directly charge users for the premium service. In either case, the mobile service server may directly track data usage associated with the particular whitelisted URL or may request or retrieve usage data from the MNO. This determined or received data usage may be used for billing the data usage charges to the sponsor or as metrics of data usage for particular URLs (e.g., the number of view for a particular streamed television show associated with a whitelisted URL). Moreover, the mobile service server may perform these tasks of tracking and determining data usage for MNOs in different countries, using different currencies, etc.

The mobile service server may execute a payments module stored on the memory of the mobile service server to allow a subscriber, after creating an account and logging into the account, to seamlessly send a mobile payment from a mobile device associated with one MNO to another subscriber's mobile device that is associated with a different MNO. This mobile payment may be executed entirely from a website or mobile app associated with the mobile service server by using a mobile wallet of the subscriber that associated with the subscriber's MNO or another third party payment provider. Moreover, the mobile service server may execute a commerce module stored on the memory of the mobile service server to allow subscribers who are users of the mobile service server to post items, products, or services for sale for other subscribers or users not affiliated with the mobile service server. After logging into a previously created account, a subscriber may browse products posted by other sellers, select a particular product, and buy the product by using a financial service engine associated with the subscriber's MNO or another third party payment provider. After the payment is authorized by the third party payment provider, the mobile service server may confirm the order and send an order confirmation notification to the buyer.

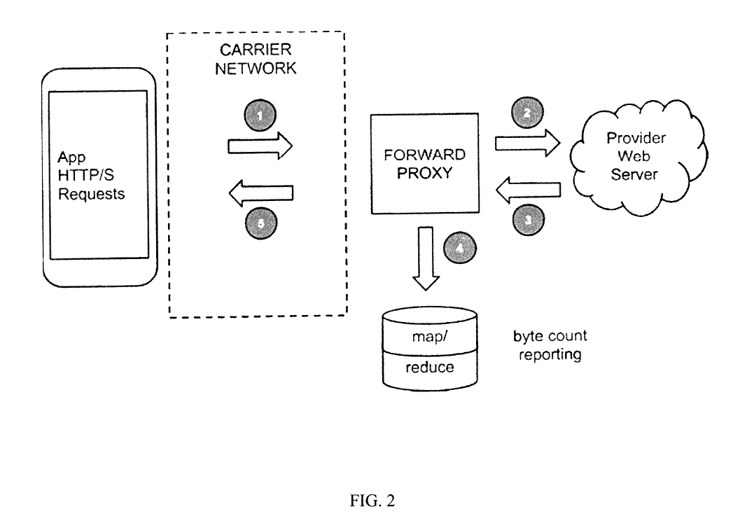

FIG. 2 illustrates a routine process or flow diagram of an embodiment of the mobile service system for performing mobile device data accounting. In such embodiments, the process in FIG. 2 can perform data accounting to keep a running account total for the amount of data transferred to subscribers that access a sponsor's whitelisted URL. It is also contemplated, however, that the data accounting can be implemented to track other types data transfer totals, and data totals transferred to individual subscribers for one or multiple sponsors.

In one embodiment, as illustrated by the flow diagram in FIG. 2, an HTTP/S request can be made from a mobile or other device running a software application, such as a specialized application provided by a sponsored content provider. The application software can determine if the device is using mobile data and it can configure itself to use a forward proxy accessed via a carrier network, like an MNO carrier network, for its HTTP/S requests. The forward proxy request can be whitelisted by the mobile carrier and, thus, may not require payment by the subscriber or count against any data plan the subscriber may have under the MNO. The forward proxy can then verify the authenticity of the request made by the mobile device via the application and forward the request to the content provider's server if the authenticity process is successful. It is also contemplated, however, that the forward proxy need not verify authenticity in some embodiments. The content provider server can then respond to the forward proxy providing the content requested if authenticity is verified, in embodiments where authenticity verification is enabled. The forward proxy can then count the amount of request and response data, such as by counting the number of bytes being transferred toward and away from the subscriber's device. The forward proxy can also forward the response by content provider server to the subscriber's device. Once the data is accounted for, the MNO or other provider can determine the amount of data provided accessed by particular subscribers or data transferred from particular content providers. The content provider can then be billed or invoiced for the data that MNO transferred from that content provider, or whatever specific types of data for which a particular content provider has agreed to pay.

For example, a mobile subscriber or user may access a software application, web browser, etc., provided by Company A on that subscriber's mobile device. Via the application, the subscriber can select particular content relating to a sponsored content provider, e.g., Company B or Company C, to access within the application that relates to a particular HTTP/S request. A carrier network can carry the request to a forward proxy, where authentication verification can occur. The forward proxy can then forward the data request to a web server containing content provided by Company B or Company C, depending on whose content was requested. The web server responds to the proxy request by delivering the requested content to the forward proxy, who forwards the content to the mobile device over the carrier network. The forward proxy can also report the amount of data transferred for such a request, and specify which company's content was transferred. If the content is provided by Company B and is associated with a URL indicated by Company B to be a whitelisted URL, the data transferred by the carrier network as a result of that request will be counted, stored, and designated as data pertaining to Company B. Similarly, if the content is provided by Company C and is associated with a URL indicated by Company C to be a whitelisted URL, the data transferred by the carrier network as a result of that request will be counted, stored, and designated as data pertaining to Company C. Company B and Company C can then be invoiced or otherwise held responsible for payment associated with the amount of data transferred by the carrier network pertaining to each respective company.

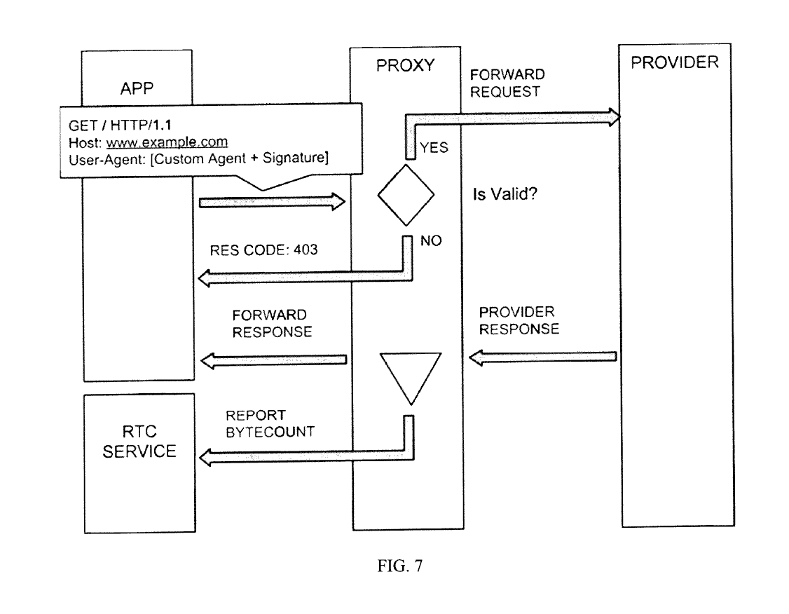

FIG. 7 illustrates a workflow diagram of an embodiment of a proxy-forwarding operation and data accounting associated with the system for mobile device data accounting. To implement the workflow illustrated in FIGS. 2 and 7, for example, some embodiments include native mobile applications provided by a web service provider and other content providers, scalable forward proxy solutions, real-time data reporting and computing service (RTC) that can be used for data counting and reporting, and proxy request authentication and RTC binding. The native mobile applications can include toggling proxy forwarding for internal HTTP/S application traffic, depending on whether the device is consuming mobile data or it is connected to a WiFi network. The application can also modify all outgoing requests by appending a digital signature each user header parameter for HTTP and HTTP/S traffic. The application can also optimize web content by rendering performance and providing support to modern HTML5 standards and the Android Webview, and can provide bindings between the web view and the native application to enable essential navigation and other core actions.

In such embodiments, the RTC service can allow the proxy server to capture and report real-time traffic data via a software development kit (SDK), and can allow the compiling of data reports for each content provider in discrete time periods, on demand, or continually. The proxy can also validate incoming requests to assure they are coming from the proper web service provider or other verified party. The proxy can also report data amounts and request metadata to the RTC service prior to forwarding the proxied responses. In one embodiment, the SDK can have the interface shown below in Table 1:

### Table 1

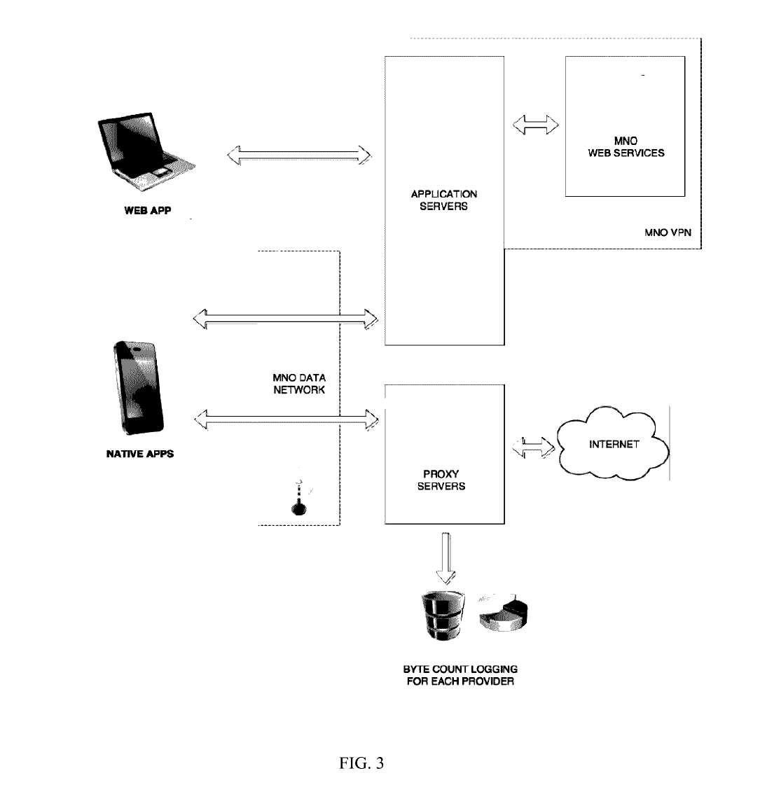

One embodiment of a computer environment that can support the system for data accounting is illustrated in FIG. 3. The main server infrastructure subcomponents in the illustrated embodiment of the system are the application server, the proxy server, and the MNO integration services, which are discussed in greater detail below.

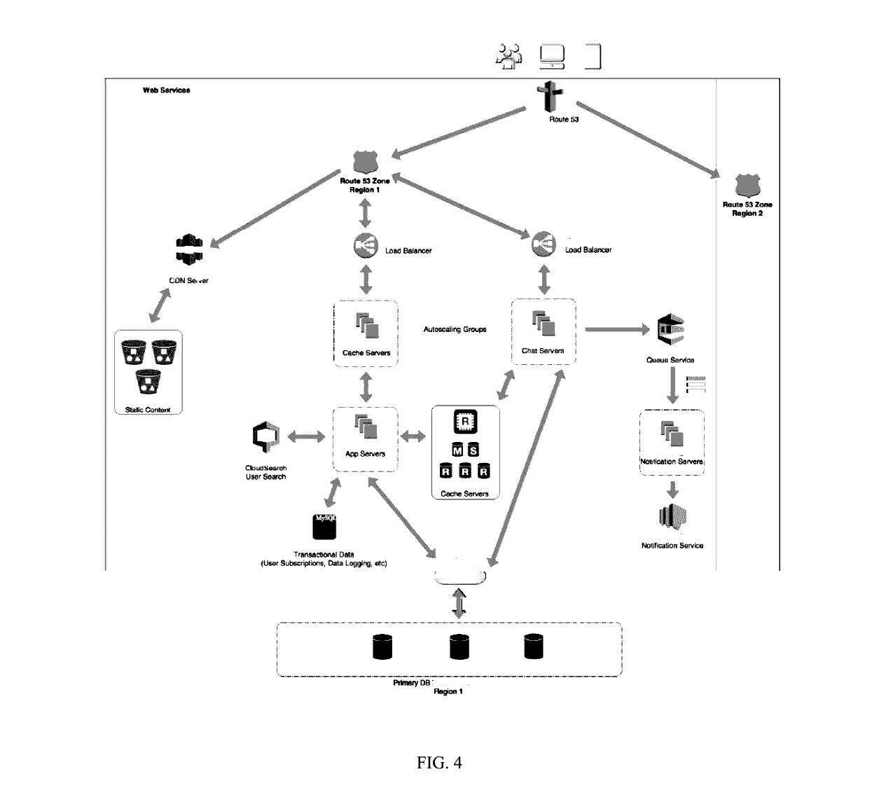

The MNO operator can provide a data network and operator services, such as carrier billing for adding and renewing the data plans, USSD and SMS integration, as well as zero-rating for a set of whitelisted URL patterns. The application servers can be a large component of the server-side infrastructure. For example, the application servers can supply client-side applications with other fundamental services including session, chat, content, and faceted search. An embodiment of an application server architecture is illustrated in FIG. 4. The application server stack can run on in a multi-region configuration, allowing low latency and high availability in a variety of global markets. The persistence layer's instances can be configured to match application server regions. Substantially identical architecture and configuration can be deployed in each global region. A DNS service can be used to direct traffic to the closest server region for each subscriber or user's geographical location.

Within each region, there can be various types of incoming web requests that the application server can handle based on the request URL. For example, Core API Requests can include session, Tone data, faceted search, and other utilities such as maps, weather, and initiating proxy requests for sponsored data. These requests can be served via a load-balanced set of cache servers or web application servers depending on the type of operation cached and uncached, and read versus write. An autoscaling group service can handle traffic demand changes by continuously monitoring the number of requests and server performance, and automatically adjusting the number of load-balanced nodes to meet any given traffic demand. Another web request can be a Chat API Request. Such a case could include serving instant requests via a load-balanced set of XMPP servers, and sending chat push notifications via an simple notification service (SNS). The autoscaling group service can automatically manage traffic demand for chat servers as well. Another web request can be a Content Delivery Network (CDN) Request. This type of web request can serve static data such as images, media, styles, and scripts. The CDN can scale automatically to meet traffic demand and can automatically route traffic to the nearest location based on the availability for the requested resource.

In some embodiments, cache layers can be introduced at multiple levels to optimize and improve overall performance and reduce response time. One caching layer can be Application Caching, where the a mobile device application can cache common read requests until they are invalidated via different mechanisms depending on the resource type and lifetime. Another caching layer can be Web Application Caching, where a web application can use a SPA (Single Page Application) architecture in order to take full advantage of in-memory cache models for document object model (DOM) objects as well as common browser-based data stores in order to keep the number of server requests low or to a minimum. Another cache layer can be Server Request Caching, where read requests can be cached by a set of cache servers which can help reduce the application server requests and improve performance. Another cache layer can be Application In-Memory Cache, which can be used to serve a small number of objects such as configuration files, connection pools, or service states. Another cache layer can be Application Key-Value Pairs (KVP) Datastore/Database (DB) Cache, which can provide a layer of scalable in-memory persistence for common read/write operations which may require a DB-Read operation therefore reducing the number of DB requests. A number of DBWrite operations can also benefit from this cache layer because a write operation can be issued both at the cache layer and the DB layer in a non-blocking async configuration. The response can then issue from the cache layer while the DBWrite operation is queued for an eventual execution. A Faceted Search can provide an indexed search solution that can allow relatively fast indexing and caching of searchable data such as users and contacts.

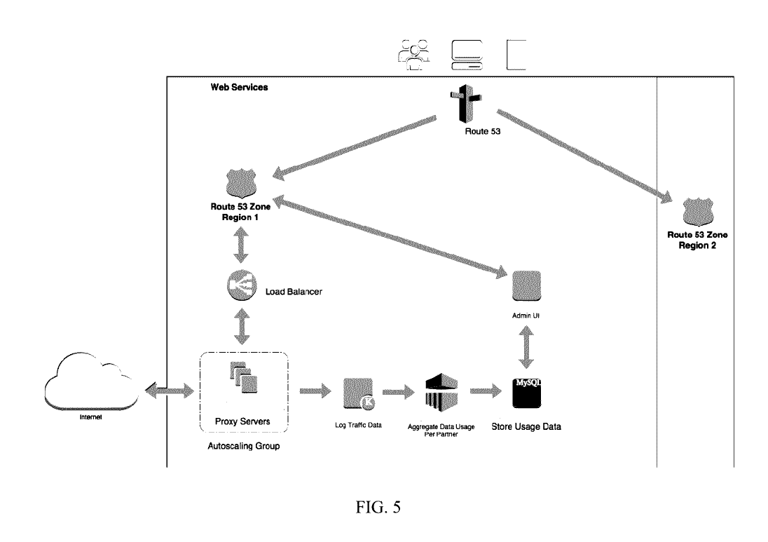

FIG. 5 illustrates an embodiment of Data Sponsoring Solution Architecture as part of the system for mobile device data accounting. Data sponsoring can be provided to brands and other third party sponsors to enable them to serve content to users that does not result in a user or subscriber data charge. This content can be a form of advertising for brands who can choose to sponsor specific content that promotes their brand, or any other content that a third party may wish to provide. Each type or piece of content can be assigned a data limit by the brand, in which case the content can be served until the data limit is reached. The brand or sponsor can then be responsible for paying for the cost of that sponsored data. In some embodiments, the sponsor can host its own content, which is then proxied using a scalable proxy solution. The proxy server can also act as a gatekeeper by counting and reporting traffic data for each sponsor as well as denying invalid unauthorized requests, as described with reference to FIG. 1. FIG. 5 illustrates one embodiment of such a proxy and traffic reporting solution.

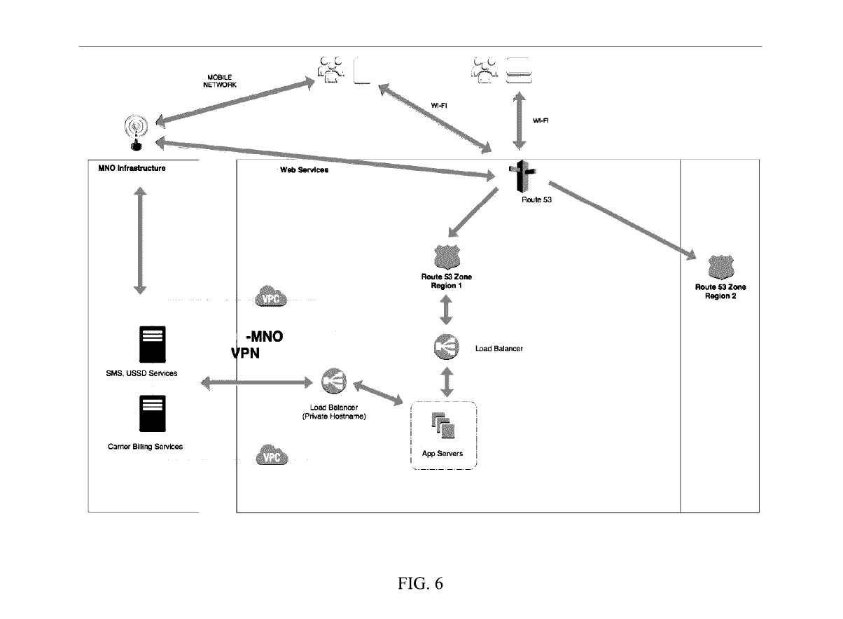

FIG. 6 illustrates one embodiment of mobile network operator integration as can be implemented in the mobile data accounting system. The mobile software application can work directly with MNOs. While integration details can vary for a given MNO, the diagram in FIG. 6 shows one exemplary architecture pattern. The diagram shows the information flow for the client and server side applications and various features of this architecture. The native mobile application can communicate with the server via the MNO mobile network or WiFi. When using mobile data through the MNO, in-application services, such as chat, can be zero-rated and, thus, do not incur a data charge for the user with a valid data plan. Signing up for the data plan can be done directly through the operator via a unstructured supplementary service data (USSD) MNO integration. The data plan can then be renewed automatically or can be canceled by the customer using the same USSD menu. A virtual private network (VPN) connection can be established between the MNO and a web services provider and can be used for operations such as data plan renewal and SSD/SMS integration.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of an mobile service system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for automatically extracting, transforming, and loading content data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for tracking data transferred to mobile devices, the method comprising:
receiving, from a first user mobile device via a digital communication network, a first user request for first content data provided by a content provider;
forwarding the user request to a provider server;
receiving, from the provider server, the first content data associated with the first user request;
forwarding, via the digital communication network, the first content data associated with the first user request to the first user mobile device;
determining, via the one or more processors, that the first content data is part of a predetermined set of whitelisted content data;
determining a first amount of data transferred to the first user mobile device when the first content data is forwarded to the first user mobile device; and
based on the determination that the first content data is part of the predetermined set of whitelisted content data, logging the first amount of data.

2. The method of claim 1, further comprising:
receiving, from a second user mobile device via the digital communication network, a second user request for second content data provided by the content provider;
forwarding the user request to the provider server;
receiving, from the provider server, the second content data associated with the second user request;
forwarding, via the digital communication network, the second content data associated with the second user request to the second user mobile device;
determining, via the one or more processors, that the second content data is part of the predetermined set of whitelisted content data;
determining a second amount of data transferred to the second user mobile device when the second content data is forwarded to the second user mobile device;
based on the determination that the second content data is part of the predetermined set of whitelisted content data, adding the second amount of data to the first amount of data to determine a total amount of data.

3. The method of claim 2, further comprising generating an invoice based on the total amount of data.
